(19) United States
(12) Patent Application Publication
(10) Pub. No.: US 2024/0362900 A1
(43) Pub. Date: Oct. 31, 2024

(54) DEVICES, SYSTEMS, AND METHODS FOR GAMIFICATION OF VIDEO ANNOTATION

(71) Applicant: L'Oreal, Paris (FR)

(72) Inventors: Mehdi DOUMI, North Plainfield, NJ (US); Diana Gonzalez, Princeton, NJ (US); Jessica Aragona, Piscataway, NJ (US)

(73) Assignee: L'Oreal, Paris (FR)

(21) Appl. No.: 18/308,936

(22) Filed: Apr. 28, 2023

(51) Int. Cl. G06V 10/778; G06V 10/94; G06V 20/40; G06V 40/20

(52) U.S. Cl. CPC G06V 10/7788; G06V 10/945; G06V 20/41; G06V 40/20

(57) ABSTRACT

Devices, systems, and methods for gamifying the process of annotating videos for maintaining engagement in the annotation process and increasing the quality and quantity of an annotated data set. Methods for gamifying annotation of gestures in a video comprise determining gamified feedback based on an input and presenting the gamified feedback to an operator to keep the operator engaged in the annotation process. Methods for gamifying annotation of self-perception gestures in a video by a subject are able to be performed by the subject without the requirement of an operator, in which case the method captures an aspect of the subject's experience and the gamification maintains or increases the subject's engagement with the annotation process. Annotated data sets are used to train artificial intelligence and machine learning systems for automated detection and characterization of subjects' gestures and self-perception gestures.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In some embodiments, a method of gamifying annotation of gestures in a video of a subject performing a gesture is provided. A video playback device depicts a video of a subject performing a gesture. A computational device receives an input from an operator that corresponds with the gesture and annotates the gesture in the video based on the input. The computational device determines gamified feedback based on the input. The computational device provides the gamified feedback to the operator to maintain or increase the operator's engagement with the annotation process.

In some embodiments, a method of gamifying annotation of self-perception gestures in a video is provided. A computational device depicts a video of a subject that comprises an image of a self-perception gesture by the subject and stores an annotation corresponding to the self-perception gesture in the video. The computational device determines gamified feedback based on the self-perception gesture or the annotation and provides the gamified feedback to the subject to maintain or increase subject engagement.

In some embodiments, a computational device for gamifying video annotation is provided. The computational device comprises circuitry for depicting a video of a subject performing a gesture; circuitry for receiving an input that corresponds with the gesture and annotating the gesture in the video based on the input; circuitry for determining a gamified feedback based on the input; and circuitry for providing the gamified feedback to maintain or increase engagement with annotation.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 shows a non-limiting example embodiment of an overview of a video annotation process that includes a subject as observed by an operator, according to various aspects of the present disclosure.

FIG. 2 shows a non-limiting example embodiment of use of an AI/ML system for detection of the presence of a cotton pad wipe in a video as may be used by a subject to remove makeup in the video, according to various aspects of the present disclosure.

FIG. 3 shows a non-limiting example embodiment of a series of gestures that are annotated by an operator and detected by an AI/ML system, as well as objective metrics that are used for characterizing subjects, products, and subject-product combinations, according to various aspects of the present disclosure.

FIG. 4 shows a non-limiting example embodiment of a system and method for gamification of video annotation, according to various aspects of the present disclosure.

FIG. 5 shows a non-limiting example embodiment of a graph and table of multi-gesture tracking as performed by an AI/ML system trained with an annotated video data set, according to various aspects of the present disclosure.

FIG. 6 shows a non-limiting example embodiment of a method of gamifying annotation of gestures in a video with an operator, according to various aspects of the present disclosure.

FIG. 7 shows a non-limiting example embodiment of a method of gamifying annotation of self-perception gestures in a video with a subject, according to various aspects of the present disclosure.

FIG. 8A shows a non-limiting example embodiment of a use of a trained AI/ML system to detect gestures in a video and produce results for an automated analysis of the video, according to various aspects of the present disclosure.

FIG. 8B shows a non-limiting example embodiment of a use of a trained AI/ML system to predict results for a subject, a product, or both, according to various aspects of the present disclosure.

FIG. 9 shows a block diagram that illustrates a non-limiting example embodiment of a computational device appropriate for use as a computational device with embodiments of the disclosure, according to various aspects of the present disclosure.

### DETAILED DESCRIPTION

Skincare product testing constitutes a significant part of the product development cycle. During product testing, a product is used by test subjects and this use is observed by operators. Live or recorded video footage of product testing by subjects is captured and studied by operators for the purpose of determining whether the product is satisfactory to the subject. The results from the footage are combined with feedback from the subjects in the form of questionnaires or question-and-answer surveys to arrive at an understanding of how well the product is received by the subject. This result can be used to drive another round of product development, wherein the product is altered to try to improve its reception with a subject in another round of testing.

Review of video footage by operators or operators can seem monotonous or repetitive to the operators or operators, and as a result, these individuals may lapse in their attention given to the review process. In instances where the operator is responsible for annotating a video for the purpose of compiling numerical information related to product use, and/or for the purpose of AI/ML model training, this lapse in attention or interest can negatively impact the quality of the test results and the AI/ML model, thereby limiting the usefulness of the study. Accordingly, the disclosure provides approaches for maintaining or increasing an operator's attention during video review and annotation of a video of a subject.

In a general aspect, the disclosure provides devices, systems, and methods for gamifying the process of annotating videos. Features of the disclosure promote maintaining engagement in the annotation process and provide an increase in the quality and quantity of an annotated data set and, as a result, an increase in the quality of an artificial intelligence and/or machine learning system (AI/ML system) trained with the data set. Methods of gamification can include usage by an operator in need of being kept engaged in the annotation process, and in addition to the operator or alternative to the operator, the methods can include usage by a subject who is using or testing a product. The approaches disclosed herein improve efficiency, productivity, and robustness of video tracking and annotation by keeping the operator (and/or the subject) alert and motivated, resulting in reduced mistakes, reduced fatigue, and improved flow with game-like feedback mechanisms.

In some embodiments, the approaches disclosed herein generate multiple training datasets for training AI/ML models to model self-perception gestures or generate new linking image data to existing self-perception gesture and gesture data, such that trained AI/ML systems automatically detect subjects' gestures and self-perception gestures. In some embodiments, an AI/ML system is used to predict test results for a given product-subject combination, such as whether the subject is expected to like or dislike the product given characteristics of the subject and properties of the product. In some embodiments, the predicted results are validated against actual results, and any difference is used to further train the AI/ML system. In some embodiments, the AI/ML system is used to expedite product testing in a commercial setting.

Operators in product testing scenarios are sometimes responsible for viewing and annotating videos of subjects using products. These operators can lose focus or attention when reviewing and annotating videos. Accordingly, in one general aspect, the disclosure provides a method of gamifying the annotation of gestures in a video to maintain or increase the operator's attention. The gestures being played in the video can include a subject using a product or interacting with themselves in the context of a use, application, or removal of a product, such as a skincare product.

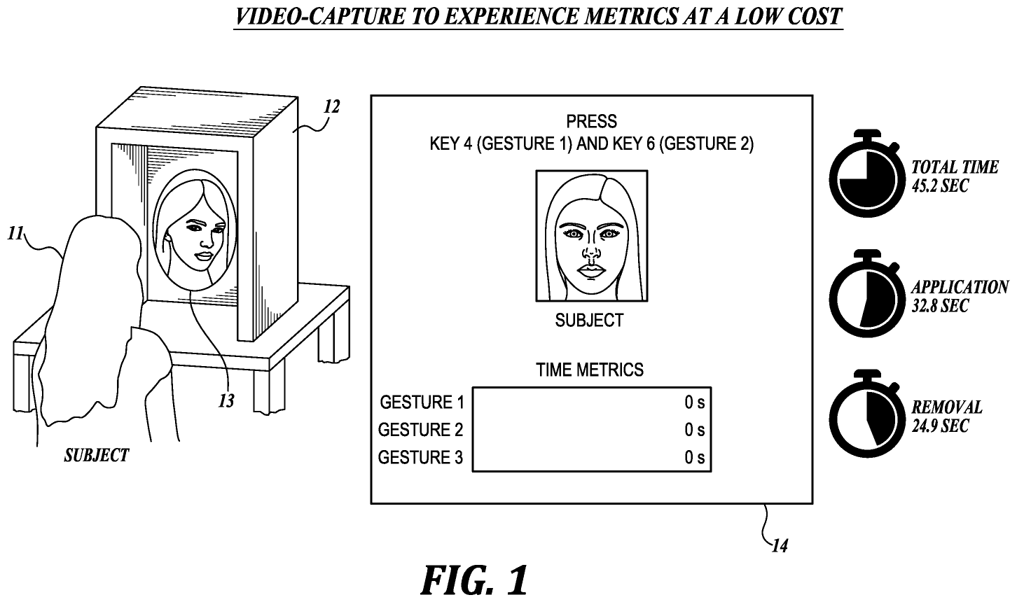

Referring now to FIG. 1, there is shown an overview of a video annotation process that includes a subject as observed by an operator. In a laboratory setting, a subject 11 sits in front of a housing 12 having a two-way mirror 13 and therein having a camera recording gestures performed by the subject 11. The two-way mirror 13 is, for example, a mirror that provides the perception of one-way transmission when one side of the mirror is brightly lit (i.e., the side of the mirror with the subject) and the other side is dark (i.e., the side of the mirror with the camera; within the housing 12). This enables viewing from the darkened side but not vice versa. The principle of operation of two-way mirrors is known in the art. As the subject 11 performs gestures (e.g., applying makeup, applying mascara, and the like), the camera records or provides a live video stream to a computational device configured to show the video or live video stream of the subject within a user interface 14 to be presented to the operator. In some embodiments the user interface 14 includes, among other features, video of the subject and instructions for pressing keys or providing another form of input when the subject performs corresponding gestures in the video or video stream. In some embodiments, the annotated video is evaluated for objective metrics associated with use of the product, including but not limited to total time, application time, and/or removal time. In some embodiments, the annotated video is used for training an AI/ML model for automated detection of gestures to supplement or replace the operator in annotating gestures in subject videos. The automated detection of gestures can be implemented as part of an AI/ML system trained and configured for visual observation and detection of gestures.

A method includes depicting, with a video playback device (e.g., a computational device), a video of a subject performing a gesture, and receiving, with a computational device, an input from an operator that corresponds with the gesture and annotating the gesture in the video based on the input. The computational device determines gamified feedback based on the input and provides the gamified feedback to the operator to maintain or increase the operator's engagement with the annotation process. In some embodiments, the video playback device is the same device as the computational device, or alternatively, these devices are separate or distinct devices.

The disclosure also provides for a video or video stream of the operator as the operator views the video of the subject, and the video or video stream of the operator is analyzed by an AI/ML system for identifying trends or correlations between characteristics of operators and the quality and/or quality of annotated data produced by the operators. These trends or correlations may be used for a variety of purposes, such as, for example, identifying potential new operators or evaluating, rewarding, or providing feedback to existing operators. As one non-limiting example, if it is discovered that there is a strong correlation between an observable feature of an operator, an observable feature of a subject, and the quality or quantity of data produced for that operator-subject combination, then future recruitment efforts for operators may focus on matching potential operators to potential subjects based on one or more of such observable features. In this manner, the study process is operated more efficiently and the quality and quantity of annotated data sets increases.

In some embodiments, subjects are performing any gesture or action in the video or video stream that is directly or indirectly related to a cosmetic product, including but not limited to makeup, skincare products such as cleansers, devices such as skin massaging devices and scraping devices, and haircare products. In some embodiments, the subject is applying a cosmetic product to the subject's body, removing the cosmetic product from the subject's body, or both. In some embodiments, the input from the operator is particular or specific to the gesture being performed by the subject. For example, the operator can press a first key when the subject performs a first gesture for a first annotation type (e.g., hand movement for applying makeup), and the operator can press a second key when the subject performs a second gesture for a second annotation type (e.g., hand movement for removing makeup with a cotton pad). Annotating the gesture in the video can comprise associating. with the computational device, the input with a portion of the video (e.g., image(s), time(s), frame(s)) at which the gesture is performed.

In some embodiments, the gamified feedback can take on any of various forms, whether visual, audio, audiovisual, text, graphics, sound, imagery, video, or other media or content, in any format, or other feedback to the operator that provides a game-like experience. In some embodiments the gamified feedback comprises, for example, depicting an amount of time left in the video; depicting a high score for the operator and/or a plurality of operators; and/or depicting a level up or a level down for the operator.

In some embodiments, the gamified feedback may be determined by any of various methods. In some embodiments, the gamified feedback is determined based on the operator's performance; for example, in some embodiments, good performance provides the basis for positive feedback (e.g., smiling face emoji, text displayed on screen, “GOOD JOB!”), while poor performance provides the basis for negative feedback (e.g., frowning face emoji, text displayed on screen, “TRY AGAIN!”). Good performance can include performance that is timely and accurate with respect to annotations, while poor performance can include performance that is not timely or is inaccurate with respect to annotations. These determinations can be made against a set of annotations for a control video, for example, or can be determined for a test video as part of a comparison between the operator's performance and one or more other operators' performance with the same video. While such a “good or bad” division of performances may be beneficial in many instances, in at least some embodiments, more complex or nuanced gamified feedback can be implemented.

In some embodiments, gamification includes a plurality of operators competing against each other for a high score, for example. In some embodiments, determining the gamified feedback comprises comparing the input, or a lack of the input, with an input received from a second operator for a comparison and depicting positive or negative feedback for the operator based on the comparison. In some embodiments, a high score table of all-time, historic high-scores is implemented as gamified feedback to provide motivation to an operator before he or she annotates a video and contributes to the historic dataset.

In some embodiments, the gamification can include one operator competing against their own previous performance. In some embodiments, determining the gamified feedback comprises comparing the input with a previous input received from the operator during a previous view of the video for a comparison and depicting a positive or negative feedback for the operator based on the comparison.

In general, gamification provides a game-like experience for the operator that increases the operator's engagement with the annotation process and increases the quality and quantity of annotated data for use in AI/ML model training and product testing.

Subjects in product testing scenarios use products and provide their feedback regarding the product experience. This feedback is typically limited to answers provided in response to questions asked by the operator or operator. The subjects can lose interest in the product testing process or unintentionally provide less-than-complete answers, which can impact the results of the test and the quality of conclusions able to be reliably drawn from the test. There is a need for subjective feedback from subjects that is not limited to a question-and-answer format and that can better reflect the subjects' true experience of the product, optionally in a non-laboratory setting, for crowdsourcing of annotation of subjects' gestures (e.g., movements of hands, lips, eyes, faces, for example, when applying or removing makeup) and self-perception gestures (e.g., facial expressions or outward expressions of thoughts, emotions, feelings, or opinions, for example, smiling). A “gesture” includes any gesture, while a “self-perception gesture” includes any gesture that is associated with a subject's self-perception.

A subject's experience with a makeup product may be driven by his or her satisfaction with how they look to themselves when wearing the product or may be driven by his or her satisfaction with how others express their perception of the subject when the subject is wearing the product. For example, the subject may smile or laugh if their experience with the makeup product is positive and may frown or distort their face if their experience is negative or ambivalent, for example. These self-perception gestures are challenging to capture and quantify in a controlled laboratory setting but hold significant value for understanding what makes a product successful. While these and other self-perception gestures can be performed in the laboratory or in the individual's daily life or in a home environment, there is a need for effective means for establishing, maintaining, and increasing subject engagement with skincare products for subject-facilitated annotation of videos for AI/ML model training. The present disclosure addresses this unmet need and provides devices, systems, and methods that are performed by subjects at any location as part of a method of crowdsourcing product testing by multiple subjects, optionally remote to a particular controlled or laboratory setting.

Accordingly, in another aspect, the disclosure provides a method of gamifying annotation of self-perception gestures in a video. The method comprises depicting, with a computational device, a video of a subject performing a gesture, receiving, with the computational device, an image of a self-perception gesture from the subject, and annotating the self-perception gesture in the video based on the image. The method further comprises determining, with the computational device, gamified feedback based on the self-perception gesture and providing, with the computational device, the gamified feedback to the subject to maintain or increase the subject's engagement with the annotation process. Subjects that do well with the annotation process, for example, high-scoring individuals, may be eligible to receive a gift or promotional award as gratitude for the subjects' contributions.

Gestures performed by subjects can comprise applying a cosmetic product to the subject's body, removing the cosmetic product from the subject's body, or both. In some embodiments, the gamified feedback is determined by any of various methods and can take on any of various forms, whether visual, audio, audiovisual, or other feedback to the operator that provides a game-like experience. In some embodiments the gamified feedback comprises, for example, feedback that is experienced by the subject as positive when the subject exhibits a positive self-perception gesture, such as a smile (e.g., the subject smiles or annotates a smile, and text on screen shows “YOU LOOK GREAT!”). Similarly, in some embodiments, gamified feedback comprises feedback that is experienced by the subject as negative or encouraging when the subject exhibits a negative self-perception gesture, such as a frown (e.g., the subject frowns or annotates a frown, and text on screen shows “TRY AGAIN!”). In at least some embodiments, gamified feedback can be provided by the subject's peers or social connections, for example, using a social media platform or virtual meeting space.

In some embodiments, the self-perception gesture comprises a facial expression, a facial contortion, a smile, a frown, a facial movement, a remark, a vocalization, or a bodily movement. For example, the subject can generate a video recording or live video stream of themselves applying makeup, and during that process may smile due to an effect the application of makeup has on their attitude or self-perception. The video recording or live video stream can be generated in an at-home or other remote environment away from a laboratory setting, or can be generated in the laboratory setting.

In some embodiments, the method further comprises receiving, with the computational device, an input from the subject that corresponds with the self-perception gesture and annotating the self-perception gesture in the video based on the input. For example, in some embodiments, the subject presses a button on the screen of a smartphone that signals to the smartphone that the subject is happy or is going to smile, and the subject may smile. The subject's smile can be annotated in the video or live stream as a result of the input from the button press. As another example, the subject may generate a facial expression that is more complex or nuanced, and the smartphone may prompt the subject for input to explain their feelings associated with that facial expression, and the device can thereby annotate the facial expression based on the explanation or other subject input. In some embodiments, the input from the subject is particular to the self-perception gesture and/or the annotating the gesture in the video comprises associating, using the computational device, the input with a portion of the video at which the gesture is performed, resulting in an annotation associated with the video that indicates the time at which a particular gesture is performed.

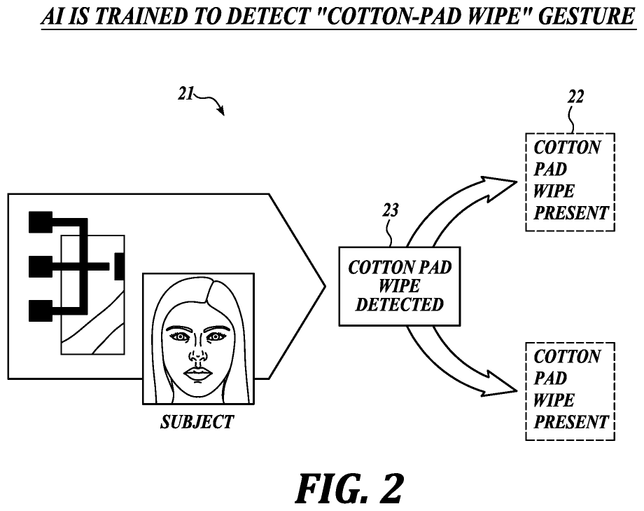

In some embodiments, annotated data sets are used to train AI/ML models for automated detection and characterization of subjects' gestures. Referring now to FIG. 2. there is shown an application 21 of an AI/ML system for detection of the presence of a cotton pad wipe in a video or video stream as may be used by a subject to remove makeup in the video or video stream. In some embodiments, an AI/ML system comprising an AI/ML model is used to detect the presence 22 of a cotton wipe when present 23 and/or to detect the absence 24 of the cotton wipe when absent 25. Automated detection of gestures can replace or supplement operator-mediated detection of gestures in the video or video stream, thereby improving the quality and quantity of experimental results that are obtained from the product testing process.

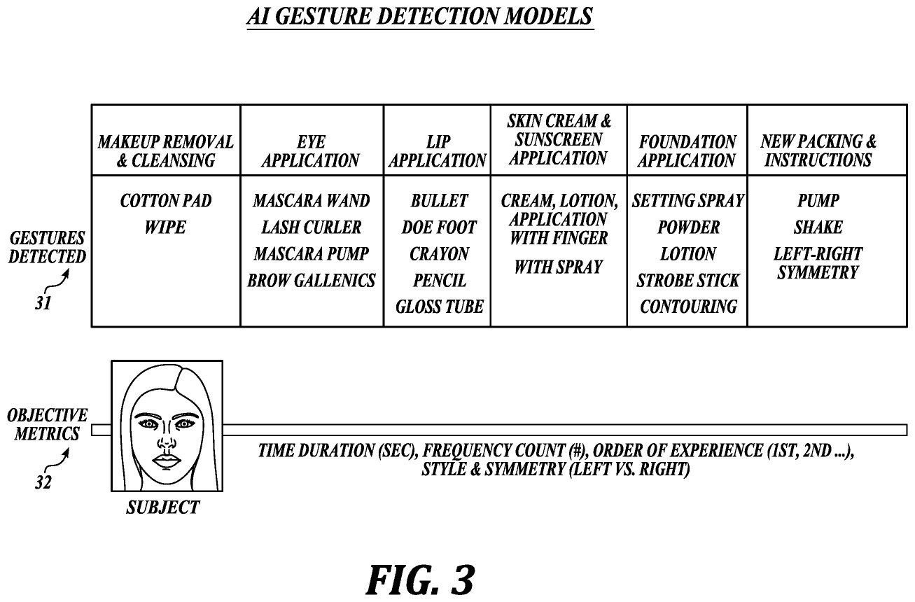

As shown at FIG. 3, in some embodiments, a variety of gestures are capable of being annotated by an operator and detected by an AI/ML system, and objective metrics used for characterizing subjects, products, and subject-product combinations. Example gestures 31 include, but are not limited to, makeup removal and cleansing (e.g., with a cotton pad wipe), eye application (e.g., with a mascara wand, a lash curler, a mascara pump, brow galenic, pencil, eyeliner, eye shadow, and the like) lip application (e.g., with a bullet, doc foot, crayon, pencil, and/or gloss tube), skin cream and sunscreen application (e.g., with cream, lotion, application with finger, and/or with a spray application), foundation application (e.g., with a setting spray, a powder, a lotion, a strobe stick, and/or contouring techniques), and interactions with new packing and instructions (e.g., pump, shake, left-right symmetry, and the like). From these gestures 31 can be derived a series of objective metrics 32 that are useful to objectively quantify the subject's interactions with the product. Example metrics 32 include, but are not limited to, time duration, frequency count, order of experience (e.g., which gestures were performed when within a sequence of gestures), and style and symmetry (e.g., which gestures were performed on which side and characteristics or metrics thereof).

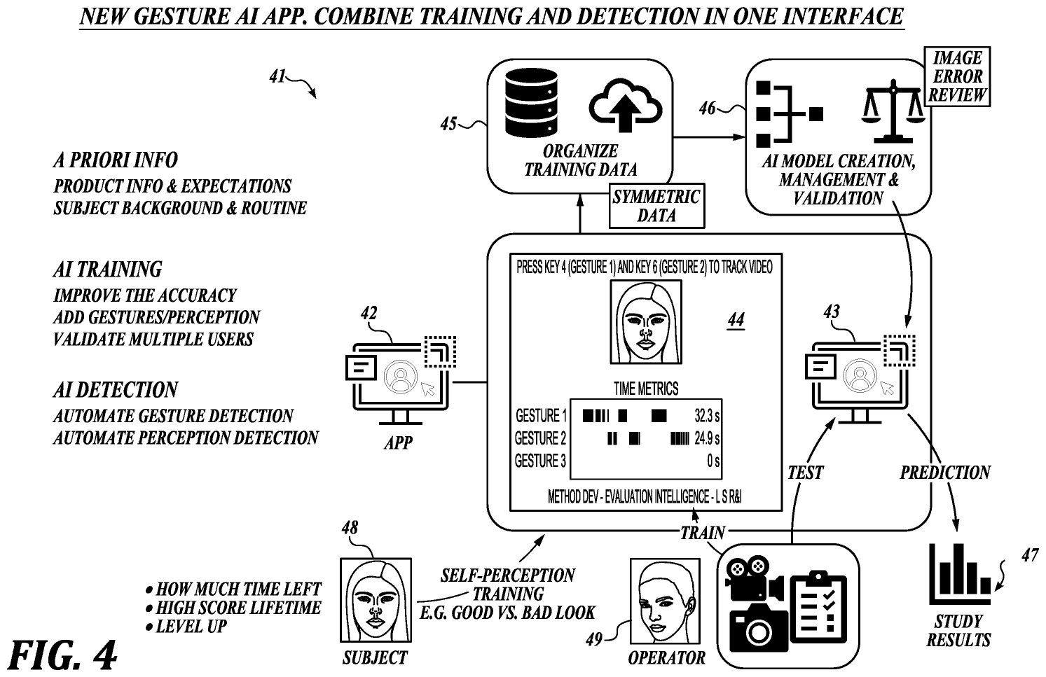

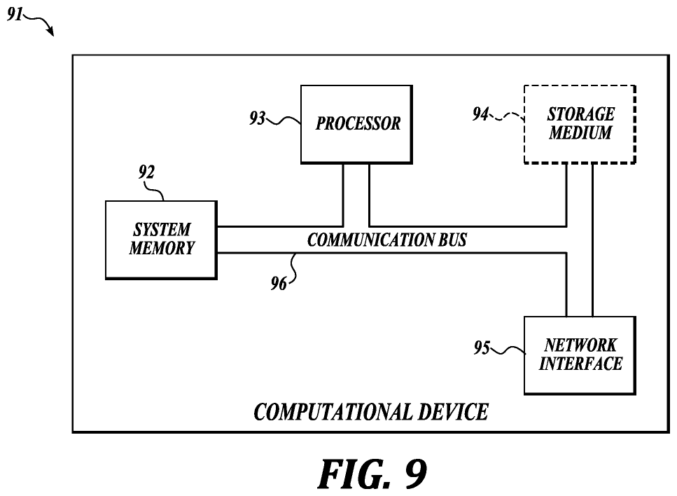

An example system 41 and method for gamification of video annotation is shown at FIG. 4. In some embodiments, system 41 includes a plurality of computational devices, e.g., one or more smartphones, one or more desktop computers, one or more tablets, or one or more other types of computational devices (see also FIG. 9 and associated description). In some embodiments, the system 41 comprises a software application or “app” 42, in the form of processor-executable instructions stored on a non-transitory computer-readable storage medium, or as circuitry or processor circuitry configured for logic operations. The app 42 causes the system 41 to carry out all or part of a method for gamification of video annotation, when executed. In some embodiments the app 42 includes as a component thereof, or can interact with, user interface 44 which is viewable by operator 49 during video annotation. In some embodiments, the subject 48 interacts with the app 42 indirectly by way of operator 49 or directly by way of a computational device accessible by the subject 48, e.g., a smartphone or tablet. In some embodiments, the app 42 executes any method disclosed herein, in whole or in part, in any order or sequence of steps. The system 41 organizes training data 45 for creation and/or training of an AI/ML model 46. In some embodiments, the AI/ML model 46 is managed and validated according to procedures known in the art and trained on training data and tested on testing data. In some embodiments, predictions 43 made by the system 41 are compared with study results 47 to determine whether the predictions 43 are sufficiently accurate or the AI/ML model need to be retrained or additionally trained.

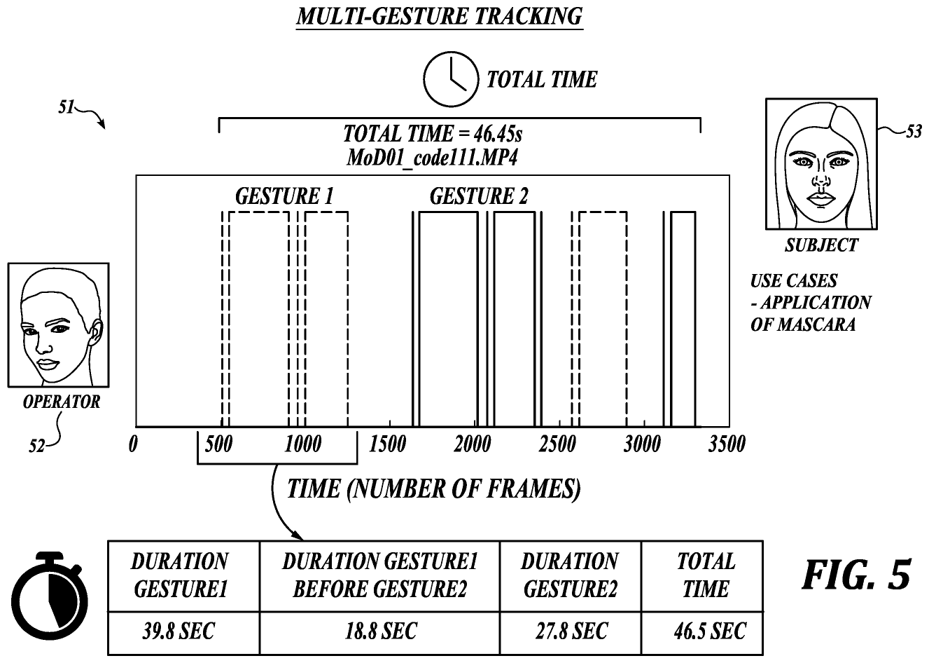

An example graph and table 51 of multi-gesture tracking as performed by an AI/ML system trained with an annotated video data set is shown at FIG. 5. In some embodiments, a graph includes time as the control (x) axis and a binary result as the result (y) axis, as shown. In this manner, an annotation can indicate presence or absence of one or more gestures during the video or video stream. These data can form the basis for metrics such as durations of gestures.

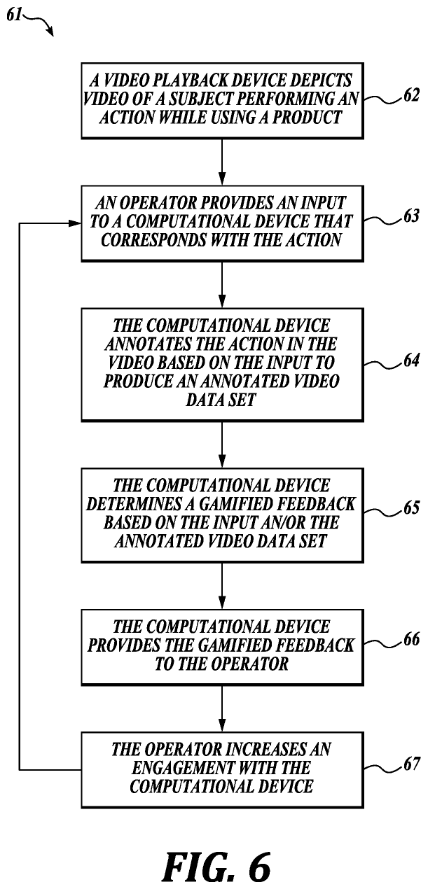

An example method 61 of gamifying annotation of gestures in a video with an operator is shown at FIG. 6. At block 62, a video playback device depicts video of a subject performing a gesture while using a product. At block 63, an operator provides an input to a computational device that corresponds with the gesture. At block 64, the computational device annotates the action in the video based on the input to produce an annotated video data set. At block 65, the computational device determines a gamified feedback based on the input and/or the annotated video data set, and at block 66, the computational device provides the gamified feedback to the operator. At block 67, as the operator views, hears, or otherwise receives or interacts with the gamified feedback, the operator increases engagement with the computational device (and the annotation process).

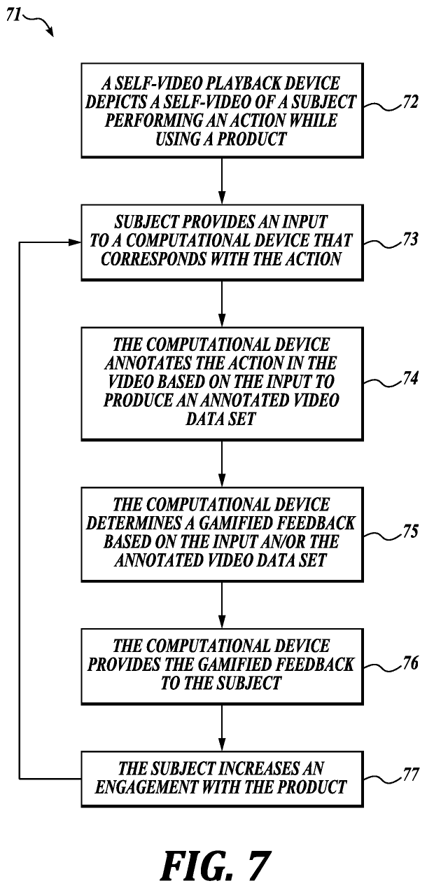

An example method 71 of gamifying annotation of self-perception gestures in a video with a subject is shown at FIG. 7. At block 72, a video playback device showing a subject a recorded video or live video stream of themselves, i.e., a self-video playback device (e.g., a computational device, a smartphone, a tablet, and the like) shows the self-video of the subject to the subject while the subject is using a product. In some embodiments the self-video playback device includes, for example, a smartphone or tablet while in a “selfie” mode of operation, wherein a live video stream of the subject is generated while the live video stream is visible to the subject. At block 73, the subject provides an input to a computational device, such as the self-video playback device, that corresponds with the action. At block 74, the computational device annotates the action in the video based on the input to produce an annotated video data set. At block 75, the computational device determines a gamified feedback based on the subject's input and/or the annotated video data set and at block 76 provides the gamified feedback to the subject. At block 77, as the subject views, hears, or otherwise receives or interacts with the gamified feedback, the subject increases engagement with the computational device (and the annotation process).

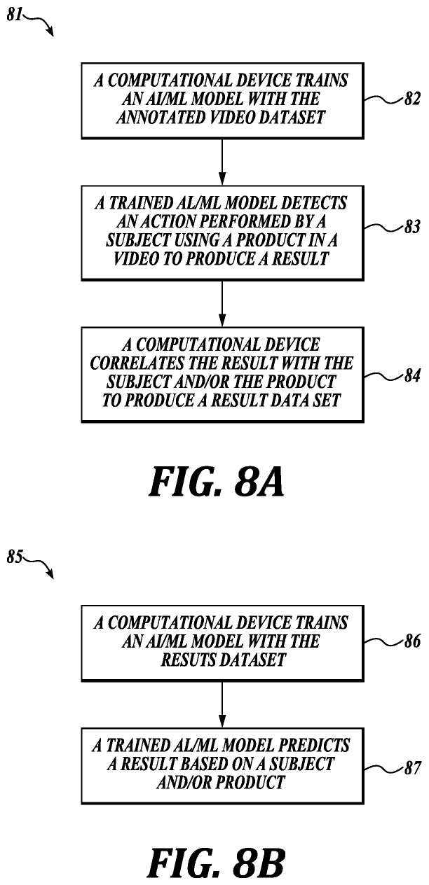

Referring now to FIGS. 8A and 8B, there are shown an example use 81 of a trained AI/ML system to detect gestures in a video and produce results for an automated analysis of the video. (FIG. 8A) and an example use 85 of a trained AI/ML system to predict results for a subject, a product, or both (FIG. 8B). As shown at FIG. 8A, a computational device trains an AI/ML model with the annotated data set 82, and the trained model detects an action performed by a subject using a product in a video to produce a result 83. While any suitable type of machine learning model can be utilized, an artificial neural network (ANN) can be utilized in an example embodiment. In addition, while any training technique can be utilized, gradient descent can be utilized in an example embodiment. The computational device then correlates the result with the subject and/or the product to produce a result data set that maps subject characteristics with product characteristics. As shown at FIG. 8B, a computational device can train an AI/ML model with the results data set to generate predictions for subject-product combinations given characteristics of the subject and characteristics of the product. The predictions can better guide product development and testing by enabling research and development teams to focus on products predicted to be more likely to be successful for a given subject.

In yet another aspect, the disclosure provides computational devices and systems configured for performing one or more methods of the disclosure, in whole or in part, in any order or sequence. In some embodiments, a computational device for gamifying video annotation comprises a processor and a non-transitory computer-readable storage medium having stored thereon instructions which when executed by the processor configure the processor to perform a method. Alternatively, the device can comprise circuitry configured to perform the method. The method performed by the computational device can comprise depicting a video of a subject performing a gesture; receiving an input that corresponds with the gesture and annotating the gesture in the video based on the input; determining, with the computational device, a gamified feedback based on the input; and providing, with the computational device, the gamified feedback to maintain or increase engagement with the method.

Referring now to FIG. 9, there is shown a block diagram that illustrates an example embodiment of a computational device 91 appropriate for use as a computational device or computational system with embodiments of the disclosure.

As used herein, “computational system” refers to one or more computational devices that are configured for performing all or part of any method of the disclosure, in any order or sequence of steps, optionally in combination with one or more other computational devices that are configured for performing all or part of any method of the disclosure, in any order or sequence of steps. In at least some instances, a method may be performed by two or more computational devices that together form at least part of a computational system, and in such instances, the steps carried out by a first computational device may be complementary to the steps carried out by a second computational device. In other instances, a method may be performed by one computational device that forms at least part of a computational system.

As used herein, “computational device” refers to a physical hardware computing device that is configured for performing all or part of any method of the disclosure, in any order or sequence of steps, optionally with human input.

While multiple different types of computational devices were discussed above, the example computational device 91 describes various elements that are common to many different types of computational devices. While FIG. 9 is described with reference to a computational device that is implemented as a device on a network, the description below is applicable to servers, personal computers, mobile phones, smart phones, tablet computers, embedded computational devices, and other devices that may be used to implement portions of embodiments of the present disclosure. Some embodiments of a computational device may be implemented in or may include an application-specific integrated circuit (ASIC), a field-programmable gate array (FPGA), or other customized device. Moreover, those of ordinary skill in the art and others will recognize that the computational device 91 may be any one of any number of currently available or yet to be developed devices.

In its most basic configuration, the computational device 91 includes at least one processor 93 and a system memory 92 connected by a communication bus 96. Depending on the exact configuration and type of device, the system memory 92 may be volatile or nonvolatile memory, such as read only memory (“ROM”), random access memory (“RAM”), EEPROM, flash memory, or similar memory technology. Those of ordinary skill in the art and others will recognize that system memory 92 typically stores data and/or program modules that are immediately accessible to and/or currently being operated on by the processor 93. In this regard, the processor 93 may serve as a computational center of the computational device 91 by supporting the execution of instructions.

A non-limiting example of instructions is software, such as software written and compiled as a MATLAB-specific-executable file that reads a video file as input. The example software enables the operator to define each key corresponding to each gesture; for example, an operator may define the ‘a’ key as being associated with the subject's application of mascara, the ‘r’ key as being associated with the subject's removal of mascara, and the ‘p’ key as being associated with counting the number of cotton pads that are used during a makeup removal experience. The example software can respond in real-time to the pressing and releasing of the computer's keyboard keys in terms of appearing and changing textual or graphic symbols, providing the result of keeping the operator alert and interested in the task at hand to provide useful data for continuing the video tracking and annotation (e.g., time left, high score, and the like).

Performance of the example software provides gamified real-time video annotation that can generate a unique dataset containing multiple dimensions of a subject-product-experience (e.g., three dimensions such as 1) time spent applying mascara, 2) time spent removing mascara, 3) number of pads). The disclosed embodiments also provide more efficient operation of video-based product studies, since study operators have less work to do during the study. For example, storing and counting cotton pads during a makeup-removal product is no longer needed, since counting pads could be done by observing the video of the subject after the study is complete. In some embodiments the software also provides more efficient study operation which means more subjects are able to be studied in a workday, thus lowering costs for fewer study days, and this also provides the ability to increase the amount of data gathered in the same amount of time. The software also provides a dramatic increase in the amount of structured, analyzable, easy-to-process-to-training data that is extractable from videos of “subject experiences”, e.g., cleansing, makeup application, makeup removal, hair brushing, and the like.

While an example software is provided as being written in MATLAB executable code, in some embodiments, the software is able to be written in any programming language and correspondingly executed on any suitably configured computational device, as is known in the art.

As further illustrated in FIG. 9, the computational device 91 may include a network interface 95 comprising one or more components for communicating with other devices over a network. Embodiments of the present disclosure may access basic services that utilize the network interface 95 to perform communications using common network protocols. The network interface 95 may also include a wireless network interface configured to communicate via one or more wireless communication protocols, such as Wi-Fi, 2G, 3G, LTE, WiMAX, Bluetooth, Bluetooth low energy, and/or the like. As will be appreciated by one of ordinary skill in the art, the network interface 95 illustrated in FIG. 9 may represent one or more wireless interfaces or physical communication interfaces described and illustrated above with respect to particular components of the computational device 91.

In the example embodiment depicted in FIG. 9, the computational device 91 also includes a storage medium 94. However, services may be accessed using a computational device that does not include means for persisting data to a local storage medium. Therefore, the storage medium 94 depicted in FIG. 9 is represented with a dashed line to indicate that the storage medium 94 is optional. In any event, the storage medium 94 may be volatile or nonvolatile, removable or nonremovable, implemented using any technology capable of storing information such as, but not limited to, a hard drive, solid state drive, CD ROM, DVD, or other disk storage, magnetic cassettes, magnetic tape, magnetic disk storage, and/or the like.

Suitable implementations of computational devices that include a processor 93. system memory 92, communication bus 96, storage medium 94, and network interface 95 are known and commercially available. For ease of illustration and because it is not important for an understanding of the claimed subject matter, FIG. 9 does not show some of the typical components of many computational devices. In this regard, the computational device 91 may include input devices, such as a keyboard, keypad, mouse, microphone, touch input device, touch screen, tablet, and/or the like. Such input devices may be coupled to the computational device 91 by wired or wireless connections including RF, infrared, serial, parallel, Bluetooth, Bluetooth low energy, USB, or other suitable connections protocols using wireless or physical connections. Similarly, the computational device 91 may also include output devices such as a display, speakers, printer, and the like. Since these devices are well known in the art, they are not illustrated or described further herein.

### NON-LIMITING EMBODIMENTS

While general features of the disclosure are described and shown and particular features of the disclosure are set forth in the claims, the following Non-Limiting Embodiments relate to features, and combinations of features, that are explicitly envisioned as being part of the disclosure. The following Non-Limiting Embodiments are modular and can be combined with each other in any number, order, or combination to form a new Non-Limiting Embodiment, which can itself be further combined with other Non-Limiting Embodiments. For example, Embodiment 1 can be combined with Embodiment 2 and/or Embodiment 3, which can be combined with Embodiment 4, and so on.

Embodiment 1. A method of gamifying annotation of gestures in a video of a subject performing a gesture, the method comprising: receiving, by a computational device, an input from an operator viewing the video of the subject that corresponds with the gesture; storing, by the computational device, an annotation corresponding to the gesture in the video based on the input; determining, by the computational device, a gamified feedback based on the input; and providing, by the computational device, the gamified feedback to the operator to maintain or increase operator engagement.

Embodiment 2. The method of any other Embodiment, wherein the gesture comprises at least one of applying a cosmetic product, removing a cosmetic product.

Embodiment 3. The method of any other Embodiment, wherein the input from the operator identifies the gesture, and wherein storing the annotation corresponding to the gesture in the video based on the input comprises associating, with the computational device, the input with a portion of the video at which the gesture is performed.

Embodiment 4. The method of any other Embodiment, further comprising at least one of: depicting an amount of time left in the video; depicting a high score for the operator and/or a plurality of operators; or depicting a level up or a level down for the operator.

Embodiment 5. The method of any other Embodiment, further comprising: comparing the input with other inputs for a comparison and depicting a positive or negative feedback for the operator based on the comparison; comparing the input with an input received from a second operator for a comparison and depicting a positive or negative feedback for the operator based on the comparison; or comparing the input with a previous input received from the operator during a previous view of the video for a comparison and depicting a positive or negative feedback for the operator based on the comparison.

Embodiment 6. A method of gamifying annotation of self-perception gestures in a video, the method comprising: depicting, by a computational device, a video of a subject that comprises an image of a self-perception gesture by the subject; storing, by the computational device, an annotation corresponding to the self-perception gesture in the video; determining, with the computational device, a gamified feedback based on the self-perception gesture or the annotation; and providing, with the computational device, the gamified feedback to the subject to maintain or increase subject engagement.

Embodiment 7. The method of any other Embodiment, wherein the subject is applying a cosmetic product to a body portion of the subject, removing the cosmetic product from the body portion of the subject, or both, in the video of the subject.

Embodiment 8. The method of any other Embodiment, wherein the self-perception gesture comprises at least one of a facial expression, a facial contortion, a smile, a frown, a facial movement, a remark, a vocalization, or a bodily movement.

Embodiment 9. The method of any other Embodiment, further comprising: receiving, by the computational device, an input from the subject that corresponds with the self-perception gesture; and generating, by the computational device, the annotation based on the input, wherein the annotation identifies the self-perception gesture in the video.

Embodiment 10. The method of any other Embodiment, wherein generating the annotation identifying the self-perception gesture in the video based on the input comprises associating, with the computational device, the input with a portion of the video at which the gesture is performed.

Embodiment 11. A computational device for gamifying video annotation, the computational device comprising circuitry configured to perform a method, the method comprising: depicting a video of a subject performing a gesture; receiving an input that corresponds with the gesture and annotating the gesture in the video based on the input; determining, with the computational device, a gamified feedback based on the input; and providing, with the computational device, the gamified feedback to maintain or increase engagement with annotation.

Embodiment 12. The computational device of any other Embodiment, wherein the gesture comprises applying a cosmetic product to a body portion of the subject, removing the cosmetic product from the body portion of the subject, or both.

Embodiment 13. The computational device of any other Embodiment, wherein the input is received from the subject or an operator and the gamified feedback is provided to the subject or the operator.

Embodiment 14. The computational device of any other Embodiment, wherein the method further comprises: depicting an amount of time left in the video; depicting a high score for the operator and/or a plurality of operators; depicting a level up or a level down for the operator; comparing the input, or a lack of the input, with an input received from a second operator for a comparison and depicting a positive or negative feedback for the operator based on the comparison; or comparing the input with a previous input received from the operator during a previous view of the video for a comparison and depicting a positive or negative feedback for the operator based on the comparison.

Embodiment 15. The computational device of any other Embodiment, wherein the method further comprises: receiving, with the computational device, an image of a self-perception gesture from the subject and annotating the self-perception gesture in the video based on the image; wherein the self-perception gesture comprises a facial expression, a facial contortion, a smile, a frown, a facial movement, a remark, a vocalization, or a bodily movement.

While illustrative embodiments have been illustrated and described, it will be appreciated that various changes can be made therein without departing from the spirit and scope of the invention.

The embodiments of the invention in which an exclusive property or privilege is claimed are defined as follows:

1. A method of gamifying annotation of gestures in a video of a subject performing a gesture, the method comprising:
receiving, by a computational device, an input from an operator viewing the video of the subject that corresponds with the gesture;
storing, by the computational device, an annotation corresponding to the gesture in the video based on the input;
determining, by the computational device, a gamified feedback based on the input; and
providing, by the computational device, the gamified feedback to the operator to maintain or increase operator engagement.

2. The method of claim 1, wherein the gesture comprises at least one of applying a cosmetic product, removing a cosmetic product.

3. The method of claim 1, wherein the input from the operator identifies the gesture, and wherein storing the annotation corresponding to the gesture in the video based on the input comprises associating, with the computational device, the input with a portion of the video at which the gesture is performed.

4. The method of claim 1, further comprising at least one of:
depicting an amount of time left in the video;
depicting a high score for the operator and/or a plurality of operators; or
depicting a level up or a level down for the operator.

5. The method of claim 1, further comprising:
comparing the input with other inputs for a comparison and depicting a positive or negative feedback for the operator based on the comparison;
comparing the input with an input received from a second operator for a comparison and depicting a positive or negative feedback for the operator based on the comparison; or
comparing the input with a previous input received from the operator during a previous view of the video for a comparison and depicting a positive or negative feedback for the operator based on the comparison.

6. A method of gamifying annotation of self-perception gestures in a video, the method comprising:
depicting, by a computational device, a video of a subject that comprises an image of a self-perception gesture by the subject;
storing, by the computational device, an annotation corresponding to the self-perception gesture in the video;
determining, with the computational device, a gamified feedback based on the self-perception gesture or the annotation; and
providing, with the computational device, the gamified feedback to the subject to maintain or increase subject engagement.

7. The method of claim 6, wherein the subject is applying a cosmetic product to a body portion of the subject, removing the cosmetic product from the body portion of the subject, or both, in the video of the subject.

8. The method of claim 6, wherein the self-perception gesture comprises at least one of a facial expression, a facial contortion, a smile, a frown, a facial movement, a remark, a vocalization, or a bodily movement.

9. The method of claim 6, further comprising:
receiving, by the computational device, an input from the subject that corresponds with the self-perception gesture; and
generating, by the computational device, the annotation based on the input, wherein the annotation identifies the self-perception gesture in the video.

10. The method of claim 9, wherein generating the annotation identifying the self-perception gesture in the video based on the input comprises associating, with the computational device, the input with a portion of the video at which the gesture is performed.

11. A computational device for gamifying video annotation, the computational device comprising circuitry configured to perform a method, the method comprising:
depicting a video of a subject performing a gesture;
receiving an input that corresponds with the gesture and annotating the gesture in the video based on the input;
determining, with the computational device, a gamified feedback based on the input; and
providing, with the computational device, the gamified feedback to maintain or increase engagement with annotation.

12. The computational device of claim 11, wherein the gesture comprises applying a cosmetic product to a body portion of the subject, removing the cosmetic product from the body portion of the subject, or both.

13. The computational device of claim 11, wherein the input is received from the subject or an operator and the gamified feedback is provided to the subject or the operator.

14. The computational device of claim 13, wherein the method further comprises:
depicting an amount of time left in the video;
depicting a high score for the operator and/or a plurality of operators;
depicting a level up or a level down for the operator;
comparing the input, or a lack of the input, with an input received from a second operator for a comparison and depicting a positive or negative feedback for the operator based on the comparison; or
comparing the input with a previous input received from the operator during a previous view of the video for a comparison and depicting a positive or negative feedback for the operator based on the comparison.

15. The computational device of claim 11, wherein the method further comprises:
receiving, with the computational device, an image of a self-perception gesture from the subject and annotating the self-perception gesture in the video based on the image;
wherein the self-perception gesture comprises a facial expression, a facial contortion, a smile, a frown, a facial movement, a remark. a vocalization, or a bodily movement.
